(19) United States
(12) Patent Application Publication
(10) Pub. No.: US 2020/0202578 A1
(43) Pub. Date: Jun. 25, 2020

(54) METHOD AND DEVICE TO CONTROL A VIRTUAL REALITY DISPLAY UNIT

(71) Applicant: Siemens Healthcare GmbH, Erlangen (DE)

(72) Inventors: Anton EBERT, Nuernberg (DE); Florian HAGER, Erlangen (DE)

(73) Assignee: Siemens Healthcare GmbH, Erlangen (DE)

(21) Appl. No.: 16/710,219

(22) Filed: Dec. 11, 2019

(30) Foreign Application Priority Data
Dec. 19, 2018 (EP) 18214034.3

(51) Int. Cl. G06T 11/00; G06K 9/62; G06K 9/00; G01B 11/25

(52) U.S. Cl. CPC G06T 11/00; G06K 9/6267; G06T 2210/41; G06K 9/6202; G01B 11/2513; G06K 9/00671

(57) ABSTRACT

A method is used to control a virtual reality display unit. The method, in an embodiment, includes tracking an environment of a space surrounding the virtual reality display unit; automatically identifying and separating real-world objects of the environment tracked by forming virtual objects and providing individual identification labels to the virtual objects; classifying the virtual objects and corresponding individual identification labels into an object-library; marking a number of the virtual objects, at least one of by a user of the virtual reality display unit and automatically by linking an individual relevance-marker with each of the respective virtual objects; and displaying the virtual objects of the object-library via the virtual reality display unit, in dependence of respective relevance-markers. A respective device and a virtual reality display unit are further included.

### PRIORITY STATEMENT

The present application hereby claims priority under 35 U.S.C. § 119 to European patent application number EP18214034.3 filed Dec. 19, 2018, the entire contents of which are hereby incorporated herein by reference.

### FIELD

Embodiments of the invention generally relate to a method and a device to control a virtual reality display unit, as well as a virtual reality display unit, especially for the use in a medical environment.

### BACKGROUND

Virtual reality (or short “VR”) is a technique where a simulated environment is shown to a user by a virtual reality display unit. The user may change the simulated environment by his actions. In addition to a visual feedback, most virtual reality display units also allow auditory or even haptic feedback. Current virtual reality display units are often virtual reality headsets or multi-projected environments, wherein headsets are preferred in the following.

While VR provides a (often nearly perfect) simulated environment, the surrounding “real world” is invisible to the user (in difference to augmented reality that is not a part of the further description). Thus, it is not possible to see, select or modify real-world objects (e.g. characteristics or position) which represent physical objects in a real room while being in virtual reality. Therefore, interaction with the real world room is very difficult while being in VR. Apart from the modification of real-world objects, it is difficult to prevent a person being in VR to walk against a real world object or to interact with for example a keyboard while being in VR.

Currently, there exist different solutions. One example solution uses a tracker which is attached to a keyboard to see the keyboard while being in virtual reality. another example solution provides the possibility to change for example the texture of a virtual landscape but it is not possible to include real-world objects into the scene and modify them.

### SUMMARY

At least one embodiment of the invention provides an improved method and device to control a virtual reality display unit as well as a virtual reality display unit that overcome the problems described above.

Embodiments are directed to a method, a device, a virtual reality display unit, a computer program product and a computer-readable medium.

A method according to at least one embodiment of the invention, to control a virtual reality display unit, comprises:

tracking an environment of a space surrounding the virtual reality display unit;

automatically identifying and separating real-world objects of the environment tracked by forming virtual objects and providing individual identification labels to the virtual objects;

classifying the virtual objects and corresponding individual identification labels into an object-library;

marking a number of the virtual objects, at least one of by a user of the virtual reality display unit and automatically by linking an individual relevance-marker with each of the respective virtual objects; and

displaying the virtual objects of the object-library via the virtual reality display unit, in dependence of respective relevance-markers.

A device according to at least one embodiment of the invention, to control a virtual reality display unit, comprises the following components:

a tracking unit, to track environment of a space surrounding the virtual reality display unit;

an identification unit, to automatically identify and separate real-world objects of the tracked environment by forming virtual objects and providing individual identification labels to the virtual objects;

a classification unit, to classify the virtual objects and corresponding individual identification labels into an object-library;

a marking unit, to mark a number of the virtual objects at least one of by a user of the virtual reality display unit and by automatically by linking an individual relevance-marker with each of the respective virtual objects; and

a data interface, communicate with the virtual reality display unit to display the virtual objects of the object-library by the virtual reality display unit, in dependence of respective relevance-markers.

A virtual reality display unit, according to at least one embodiment of the invention, includes the device of an embodiment, wherein the device is arranged in a housing of the virtual reality display unit.

A non-transitory computer program product, according to at least one embodiment of the invention, stores a computer program, directly loadable into a memory of a computer unit, including program elements for performing the method of an embodiment when the computer program is executed by the computer unit.

A non-transitory computer-readable medium, according to at least one embodiment of the invention, stores program elements, readable and executable by a computer unit, to perform the method of an embodiment when the program elements are executed by the computer unit.

At least one embodiment of the invention is also achieved by a computer program product with a computer program that is directly loadable into the memory of a computing unit, and which comprises program units to perform at least one embodiment of the inventive method when the program is executed by the control unit. In addition to the computer program, such a computer program product can also comprise further parts such as documentation and/or additional components, also hardware components such as a hardware key (dongle etc.) to facilitate access to the software.

At least one embodiment is directed to a computer readable medium such as a memory stick, a hard-disk or other transportable or permanently-installed carrier can serve to transport and/or to store the executable parts of the computer program product so that these can be read from a processor unit of a computing unit. A processor unit can comprise one or more microprocessors or their equivalents.

### BRIEF DESCRIPTION OF DRAWINGS

Other objects and features of the present invention will become apparent from the following detailed descriptions considered in conjunction with the accompanying drawings. It is to be understood, however, that the drawings are designed solely for the purposes of illustration and not as a definition of the limits of the invention.

FIG. 1 shows a block diagram of an example of the method according to an embodiment of the invention,

FIG. 2 outlines a preferred device according to an embodiment of the invention,

FIG. 3 shows a scene clarifying the method according to an embodiment of the invention,

FIG. 4 shows another scene clarifying the method according to an embodiment of the invention,

FIG. 5 shows another scene clarifying the method according to an embodiment of the invention,

FIG. 6 shows another scene clarifying the method according to an embodiment of the invention.

In the diagrams, like numbers refer to like objects throughout. Objects in the diagrams are not necessarily drawn to scale.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCam1, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (procesor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

A method according to at least one embodiment of the invention, to control a virtual reality display unit, comprises:

Track the environment of a space surrounding the virtual reality display unit. The environment is the variety of real-world objects located in the tracked space. The space could generally be any space around the virtual reality display unit. Typically, the space is a certain room defined by walls (that could also be recognized as real-world objects), wherein this room is preferably used for a medical use. Generally the tracking of an environment is well known to the skilled person, preferred embodiments of this tracking are described more accurately in the following.

Automatically identify and separate real-world objects of the tracked environment by forming virtual objects and providing an individual identification labels to the virtual objects. Here, real-world objects are recognized as objects and a virtual object is created with properties of a corresponding real-world object (at least in respect to position and geometry). The virtual object is then labelled by an individual identification label. How this is achieved in praxis, is well known to the skilled person. For example, a real-world object can be identified by detecting edges of a structure in an image and comparing them with a predefined set of templates (examples of objects). The recognized structure (pixels) in the image or the template could then be used as virtual object and be labelled with an individual number or name.

Classify the virtual objects together with their individual identification label into an object-library. Especially, the virtual objects are cut out of the scene (preferred but not necessary) and receive an ID, e.g. an integer number, an address or a name. Although it is preferred that every virtual object is labelled, this is not necessary for all possible applications.

Marking a number of virtual objects by linking an individual relevance-marker with each virtual object. This could be achieved by a user of the virtual reality display unit and/or automatically. For example, a binary marker with “1” for relevant and “0” for irrelevant could be applied to the virtual objects. It is preferred that every virtual object is marked, however, this is not necessary for all possible applications.

Displaying the virtual objects of the object-library by the virtual reality display unit in dependence of their relevance-marker. The virtual objects are shown at the positions of the real-world objects. To achieve that, it is preferred to register the virtual objects with the real-world-objects tracked. Due to the tracking, the position and geometric dimensions of the real-world objects is well known. Due to the registration, the virtual objects will have the same geometric dimensions, the same position (and the same orientation) as the real world objects. Thus, they will be exactly displayed there, where the real-world objects would be seen. The relevance of the virtual objects in the object library can be determined based on the relevance-marker or derived directly from the relevance-marker (see e.g. above example with the binary relevance-marker).

It should be noted that the surrounding “real world” is invisible to the user. Thus, the displaying step is not meant to be a display in the manner of augmented reality, but a display of virtual reality. Thus, it is not possible to see real-world objects in a real room by the virtual reality display unit, but only virtual objects that are displayed.

It is preferred that for keeping an accurate positioning of the virtual objects, the above tracking step together with a registration of the displayed virtual objects with the real-world objects is repeated at least in the case the virtual reality display device is moved. This is described below more accurately.

A device according to at least one embodiment of the invention, to control a virtual reality display unit, comprises the following components:

A tracking unit designed to track the environment of a space surrounding the virtual reality display unit. Such tracking unit is well known in the art and is often arranged on the virtual reality device or on the user of this device. Typically the tracking is achieved by using infrared light.

An identification unit designed to automatically identify and separate real-world objects of the tracked environment by forming virtual objects and providing individual identification labels to the virtual objects.

A classification unit designed to classify the virtual objects together with their individual identification label into an object-library.

A marking unit designed to mark a number of virtual objects by a user of the virtual reality display unit and/or automatically by linking an individual relevance-marker with each virtual object.

A data interface designed to communicate with the virtual reality display unit in a way to display the virtual objects of the object-library by the virtual reality display unit in dependence of their relevance-marker.

A virtual reality display unit according to the invention, comprises a device according to the invention, wherein the components of the device are preferably arranged in the housing of the virtual reality display unit.

A medical device, e.g. a medical measuring device and/or a medical imaging device (e.g. a magnetic resonance imaging system or an X-ray computed tomography system) according to the invention comprises a device according to the invention and a data interface designed to connect with a virtual reality display unit.

At least one embodiment of the invention has the advantage that relevant objects of the real world can be displayed in virtual reality, wherein an interaction with these objects is possible. Another advantage of at least one embodiment is that irrelevant objects could be omitted in the display of the virtual reality display unit or that their visual characteristics could be changed (e.g. with a uniform texture to prevent bumping into real-world objects). This especially enhances the recording of trainings in hospitals. At least one embodiment of the invention is especially designed for medical use.

The units or modules of the device mentioned above, can be completely or partially realized as software modules running on a processor of a computing unit. A realization largely in the form of software modules can have the advantage that applications already installed on an existing system can be updated, with relatively little effort, to install and run at least one embodiment of the method of the present application.

At least one embodiment of the invention is also achieved by a computer program product with a computer program that is directly loadable into the memory of a computing unit, and which comprises program units to perform at least one embodiment of the inventive method when the program is executed by the control unit. In addition to the computer program, such a computer program product can also comprise further parts such as documentation and/or additional components, also hardware components such as a hardware key (dongle etc.) to facilitate access to the software.

At least one embodiment is directed to a computer readable medium such as a memory stick, a hard-disk or other transportable or permanently-installed carrier can serve to transport and/or to store the executable parts of the computer program product so that these can be read from a processor unit of a computing unit. A processor unit can comprise one or more microprocessors or their equivalents.

Particularly advantageous embodiments and features of the invention are given by the dependent claims, as revealed in the following description. Features of different claim categories may be combined as appropriate to give further embodiments not described herein.

According to method of at least one embodiment, in order to track the environment of a space surrounding the virtual reality display unit, a scan with a default overlay grid of a light pattern is performed. This has the advantage that due to the coordinate data of the light-grid, the position and the geometric shape of the real-world objects can be scanned very accurately. Preferably an infrared grid is projected over the environment of the space, since infrared can be advantageously be detected and is invisible for humans. It is further preferred that real-world objects existing in the space (forming the environment) are shown with the default overlay grid in the virtual reality display unit.

A preferred method of at least one embodiment comprises:

checking, if the environment of the tracked space or the space to be tracked, has been tracked before, and if positive

searching an existing object-library of virtual objects of this space, and using these virtual objects in the case that the search was positive.

This has the advantage that in the case a space has been scanned before, e.g. an operation room where most of the furniture and other objects in the room are typically not moved, stored data of the object of the environment could be used. Thus, it is not necessary to perform complex calculations to recognize objects in that environment. One could simply use results of former scans. The method could check position data of the scanned space (where the tracked environment is positioned), e.g. by using a WLAN Access Point with an individual identification, and use this check to determine whether there are already stored virtual objects according to the scanned space or not. Alternatively, there can occur a tracking step and after that tracking a short evaluation could be made if the overall shape of the tracked environment matches a known shape tracked before.

According to a preferred method of at least one embodiment, in the case the search of an existing object-library was positive and a real-world object has been tracked at the position of a virtual object of the object-library and is identified as this virtual object, a stored relevance-marker of this virtual object is searched and the virtual object of the object-library is automatically assigned with this relevance-marker. This has the advantage that in a room already “known”, a former marking of virtual objects can be used as preference. Thus, in the case a physician often works in an operation room, it is not necessary to mark virtual objects every time, but simply use the settings of the last time.

It is also possible to apply this preferred method of at least one embodiment for a group of virtual objects. Any time a virtual object of a special shape is tracked (e.g. a table), it automatically is assigned to a relevance marker that is applied to the same group of virtual objects (e.g. all tables tracked). For example, every time a predefined virtual object (e.g. table) is tracked, it gets a predefined relevance-marker reserved for this sort of virtual objects.

Thus, the object-library can be used to link real-world objects with similar virtual objects of the object-library in order to overtake their characteristics. The advantage is that it can be achieved to match real world objects and virtual assets (e.g. in a Hybrid-Simulation).

According to a preferred method of at least one embodiment, the environment of the space surrounding the virtual reality display unit is tracked at least one more time.

In this case the tracking preferably is performed with a different position of the virtual reality display unit in the space and/or with a different angle of view of the virtual reality display unit. This has the advantage that the environment can be tracked more accurately, wherein especially shadowing is prevented and/or triangulation is possible.

As a preferred alternative or addition, the tracking is performed to check if the geometry of virtual objects of the object-library is matching the geometry of the respective real-world-objects. This also enhances the quality of the object-library.

Alternatively or additionally, the tracking is preferably used to automatically identify and separate further real-world objects of the tracked environment in forming virtual objects and providing an individual identification label to the new identified virtual objects. This is especially advantageous in the case stored virtual objects are used based on a former tracking. Due to the second tracking it could be determined if some of the real-world objects have been moved, added or removed.

According to a preferred method of at least one embodiment, the marking of virtual objects is performed by a user of the virtual reality display unit (e.g. additionally to an automatic marking). The virtual objects to be marked are shown as items of the object-library and/or are displayed by the virtual reality display unit (as objects). While displaying virtual objects, they are preferably displayed in a position corresponding to the position of the respective real-world objects in the environment and/or preferably as a picture of the real-world object or as a picture of an artificial object. Especially, in the case, there is existing a picture of an artificial object, a similar virtual object is displayed by using this picture. In the case there is no such picture found, a photography (picture of the real-world object) is displayed for the virtual object.

According to a preferred method of at least one embodiment, the virtual objects of the object-library are shown by the virtual reality display unit for marking and/or are not shown by the virtual reality display unit prior marking and are marked independently to the display of the virtual reality display unit. For this preferred method it is particularly preferred that a user could switch between these two possibilities for marking. Thus, instead of showing all objects and select objects of interests afterwards it could be also done the other way around and first select the objects of interest and then show them in VR. It is also possible to show a list of (virtual) objects and selecting one of the list.

According to a preferred method of at least one embodiment, the marking is performed by eye tracking (e.g. focusing), touching (e.g. shock/delay or hand tracking), with a input device, with gestures (e.g. hand tracking) or with verbal commands.

According to a preferred method of at least one embodiment, the virtual objects are marked with a relevance-marker more complex than a binary marker i.e. this relevance-marker can have more than two possible states. This could be a number, by a word or by several (binary, numeric or literal) relevance-markers. It is preferred that the relevance-markers are designed such that the relevance of the virtual objects can directly be derived from this relevance-marker. It is further preferred that the virtual objects of the object-library are shown by the virtual reality display unit in different shapes or not at all in dependence of their relevance (e.g. directly depending from their relevance-marker). For example, if the relevance-marker is zero, the virtual object is not shown at all and the higher the numeric value of the relevance-marker is the more details are shown while displaying the virtual object.

In particular it is preferred that a virtual object is not shown if its relevance lies under a predefined value and/or the virtual object is shown with a predefined texture (especially with more details the higher the relevance is) if its relevance lies between a first range of values and/or the virtual object is shown as image or video of the real object if its relevance lies between a second range of values. This image or video is preferably registered with the real-world object. It should be noted that “relevance” could be a value derived from the corresponding relevance-marker or the value of the corresponding relevance-marker itself.

This has the advantage that after selecting the objects, the physical/logical behavior (characteristics) of virtual objects can be defined. In case the objects are irrelevant, they can be suppressed. If the point is just to see the objects (for example not walk against them), an arbitrary texture is sufficient. In the case the objects are important (e.g. for recording) a video-streaming option could be applied to see the real-world objects and e.g. measured values on a screen of this real-world object.

According to a preferred method of at least one embodiment, depending on its relevance a virtual object is shown as a real-time video stream of the real object, wherein this video stream is preferably registered with the real-world object. The expression “registered” means that the position and geometric shape of the picture of the real-world object in the video stream (or above image) matches the position and geometric shape of the real-world object. Since the virtual object will be seen in VR at the same position as the real-world-object, it seems that in VR the real-world object will be at the correct position as seen from the position of the virtual reality display unit.

According to a preferred method of at least one embodiment, additional virtual objects are shown by the virtual reality display unit together with the virtual objects corresponding to real-world objects, wherein the additional virtual objects do not belong to the environment of the space.

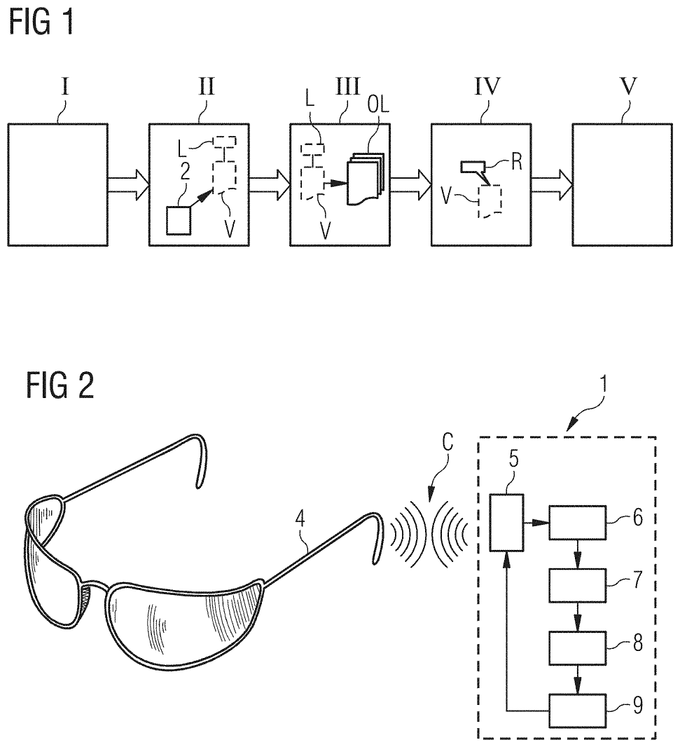

FIG. 1 shows a block diagram of an example of the method to control a virtual reality display unit 4 (see FIG. 2) according to an embodiment of the invention. The steps of the method are illustrated with boxes.

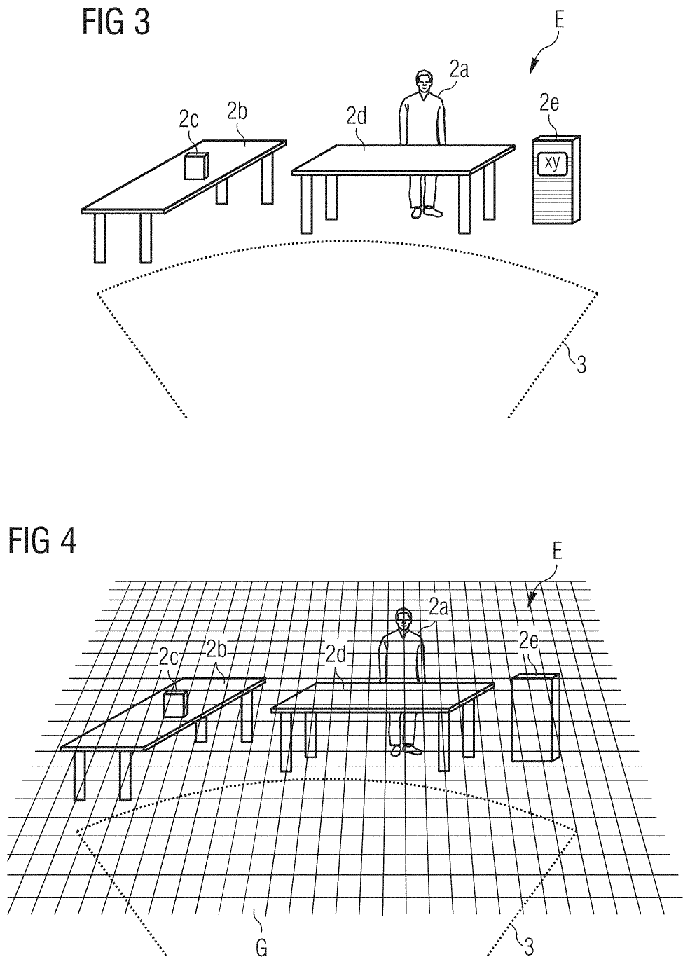

In step I, the environment E (see e.g. FIG. 3) of a space surrounding the virtual reality display unit 4 is tracked.

In step II, real-world objects 2 of the tracked environment E are automatically identified and separated in forming virtual objects V. These virtual objects V are provided with individual identification labels L.

In step III, the virtual objects V are classified together with their individual identification labels L into an object-library OL.

In step IV a number of virtual objects V are marked by linking an individual relevance-marker R with each virtual object V. This could be achieved by a user of the virtual reality display unit 4 and/or automatically.

In step V, the virtual objects V of the object-library OL are shown by the virtual reality display unit 4 in dependence of their relevance-marker R.

FIG. 2 outlines a preferred device 1 to control a virtual reality display unit 4. In the figure, the virtual reality display unit 4 is connected with the device 1 via a wireless data connection C. The device comprises the following components:

A tracking unit 6 designed to track the environment E of a space surrounding the virtual reality display unit 4. For all Reference signs not shown in FIG. 2, see FIGS. 3 to 6 displaying the process sequence.

An identification unit 7 designed to automatically identify and separate real-world objects 2, 2a, 2b, 2c, 2d, 2e of the tracked environment E in forming virtual objects V, V1, V2, V3, V4, V5, V6, V7 and providing individual identification labels L, L1, L2, L3, L4, L5 to the virtual objects V, V1, V2, V3, V4, V5, V6, V7.

A classification unit 8 designed to classify the virtual objects V, V1, V2, V3, V4, V5, V6, V7 together with their individual identification label L, L1, L2, L3, L4, L5 into an object-library OL.

A marking unit 9 designed to mark a number of virtual objects V, V1, V2, V3, V4, V5, V6, V7 by a user of the virtual reality display unit 4 and/or automatically by linking an individual relevance-marker R with each virtual object V, V1, V2, V3, V4, V5, V6, V7.

A data interface 5, here a wireless data interface, designed to communicate with the virtual reality display unit 4 in a way to show the virtual objects V, V1, V2, V3, V4, V5, V6, V7 of the object-library OL by the virtual reality display unit 4 in dependence of their relevance-marker R.

FIGS. 3 to 6 show a scene clarifying the course of the method according to an embodiment of the invention.

In FIG. 3, a possible environment E is shown that could be seen in the field of view 3 (FOV) of a virtual reality display unit 4 (see e.g. FIG. 2). There are different real-world objects 2a, 2b, 2c, 2d, 2e standing in a room. One “object” is a person 2a standing behind a table 2d. At the right side of the picture is a medical apparatus 2e showing a value of a measurement on its screen. At the left side of the picture, there is another table 2b with a box 2c standing on it.

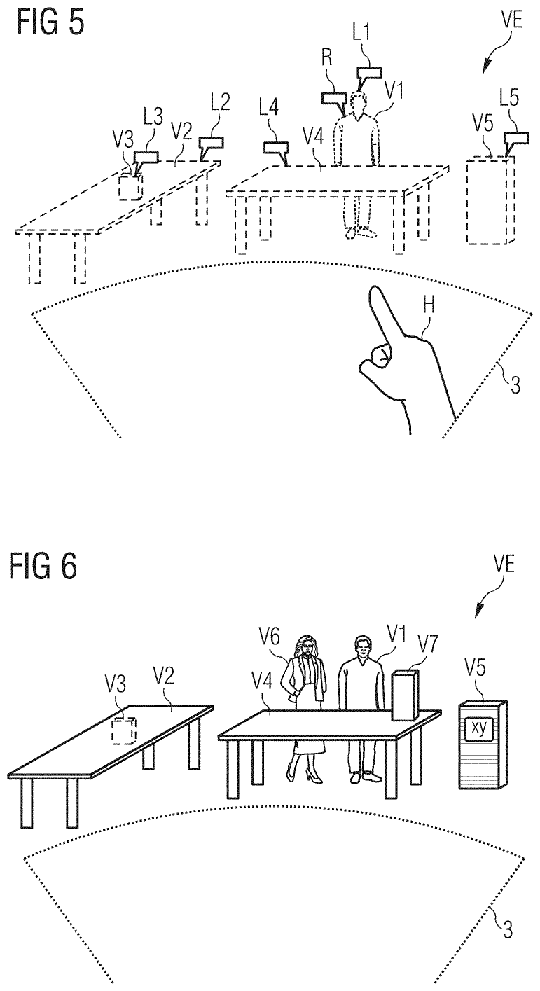

In FIG. 4, the environment E shown in FIG. 3 is tracked by overlaying a grid G formed by infrared light over the environment E. In the course of tracking, the real-world objects 2, 2a, 2b, 2c, 2d, 2e of the tracked environment E are identified and virtual objects V1, V2, V3, V4, V5 are formed (see FIG. 5).

In contrast to FIGS. 3 and 4 that are showing the real world, FIGS. 5 and 6 are showing a virtual environment VE. Thus, this is the scene that a user of a virtual reality display unit would see.

In FIG. 5, the identified virtual objects V1, V2, V3, V4, V5 are shown in a transparent way (dashed lines) together with labels L1, L2, L3, L4, L5. In order to mark a number of virtual objects V1, V2, V3, V4, V5, a user of the virtual reality display device points with his hand H at a number of virtual objects V1, V2, V3, V4, V5 shown in the virtual environment.

In FIG. 6, the virtual objects V1, V2, V3, V4, V5 are marked relevant, very relevant or not relevant at all by the user. Thus, from the left to the right, the left virtual table V2 is shown (however not very detailed) so that the user does not run into its counterpart in real-world while moving through the room. Since the virtual box V3 on the table is of no interest, it has been omitted from the virtual environment (dashed-pointed lines mean here that the object is not shown). The virtual table V4 in the middle is displayed together with a virtual avatar V1 of the person 2a. In this example, another avatar V6 is standing at the virtual table V4 and additionally a virtual box V7 is arranged on it.

At the right side, a real time video of the medical apparatus 2e is shown as virtual medical apparatus V5 in order that the user may read the measured values (from the real world) in the virtual environment VE.

Although the present invention has been disclosed in the form of preferred embodiments and variations thereon, it will be understood that numerous additional modifications and variations could be made thereto without departing from the scope of the invention. For the sake of clarity, it is to be understood that the use of “a” or “an” throughout this application does not exclude a plurality, and “comprising” does not exclude other steps or elements. The mention of a “unit” or a “device” does not preclude the use of more than one unit or module.

Although the present invention has been disclosed in the form of preferred embodiments and variations thereon, it will be understood that numerous additional modifications and variations could be made thereto without departing from the scope of the invention. For the sake of clarity, it is to be understood that the use of “a” or “an” throughout this application does not exclude a plurality, and “comprising” does not exclude other steps or elements. The mention of a “unit” or a “device” does not preclude the use of more than one unit or device.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method to control a virtual reality display unit, comprising:
tracking an environment of a space surrounding the virtual reality display unit;
automatically identifying and separating real-world objects of the environment tracked by forming virtual objects and providing individual identification labels to the virtual objects;
classifying the virtual objects and corresponding individual identification labels into an object-library;
marking a number of the virtual objects, at least one of by a user of the virtual reality display unit and automatically by linking a respective individual relevance-marker with each of the virtual objects; and
displaying the virtual objects of the object-library via the virtual reality display unit, in dependence of respective relevance-markers.

2. The method of claim 1, wherein the tracking of the environment of the space surrounding the virtual reality display unit includes
performing a scan with a default overlay grid of a light pattern.

3. The method of claim 1, further comprising:
checking, if the environment of tracked space or the space to be tracked, has been tracked before, and if positive
searching an existing object-library of virtual objects of the tracked space, and using the virtual objects upon the searching being positive.

4. The method of claim 3, wherein, upon the searching of an existing object-library being positive and upon a real-world object being tracked at a position of a respective virtual object of the object-library and being identified as the respective virtual object, a stored relevance-marker of the respective virtual object is searched and the respective virtual object of the object-library is automatically assigned with the stored relevance-marker.

5. The method of claim 1, wherein the environment of the space surrounding the virtual reality display unit is tracked at least one more time, and wherein the tracking at least one of
is performed with at least one of a different position of the virtual reality display unit in the space and a different angle of view of the virtual reality display unit, and
is checking if geometry of virtual objects of the object-library is matching geometry of respective real-world-objects, and
is used to automatically identify and separate further real-world objects of the tracked environment in forming virtual objects and providing an individual identification label to a new identified virtual objects.

6. The method of claim 1, wherein the marking of virtual objects is performed by a user of the virtual reality display unit and wherein the virtual objects to be marked at least one of:
are shown as items of the object-library, and
are displayed by the virtual reality display unit, at least one of in a position corresponding to the position of respective real-world objects in the environment and as a picture of the real-world object or of an artificial object.

7. The method of claim 1, wherein the virtual objects of the object-library are at least one of shown by the virtual reality display unit for marking and not shown by the virtual reality display unit prior marking, and the virtual objects of the object-library are marked independently to the display of the virtual reality display unit.

8. The method of claim 1, wherein the marking is performed by eye tracking, touching, with a input device, with gestures or with verbal commands.

9. The method of claim 1, wherein the virtual objects are marked with a relevance-marker including more than two possible states, and wherein the relevance of the virtual objects is directly derivable from the relevance-marker.

10. The method of claim 1, wherein depending on relevance of a virtual object, the virtual object is shown as a real-time video stream of the real-world object, and wherein the real-time video stream is registered with the real-world object.

11. The method of claim 1, wherein additional virtual objects are shown by the virtual reality display unit together with the virtual objects corresponding to real-world objects, and wherein the additional virtual objects do not belong to the environment of the space.

12. A device to control a virtual reality display unit, comprising:
a tracking unit, to track environment of a space surrounding the virtual reality display unit;
an identification unit, to automatically identify and separate real-world objects of the tracked environment by forming virtual objects and providing individual identification labels to the virtual objects;
a classification unit, to classify the virtual objects and corresponding individual identification labels into an object-library;
a marking unit, to mark a number of the virtual objects at least one of by a user of the virtual reality display unit and by automatically by linking a respective individual relevance-marker with each of the virtual objects; and
a data interface, communicate with the virtual reality display unit to display the virtual objects of the object-library by the virtual reality display unit, in dependence of respective relevance-markers.

13. A virtual reality display unit, comprising the device of claim 12, wherein the device is arranged in a housing of the virtual reality display unit.

14. A non-transitory computer program product storing a computer program, directly loadable into a memory of a computer unit, including program elements for performing the method of claim 1 when the computer program is executed by the computer unit.

15. A non-transitory computer-readable medium storing program elements, readable and executable by a computer unit, to perform the method of claim 1 when the program elements are executed by the computer unit.

16. The method of claim 2, wherein an infrared grid is projected over the environment of the space.

17. The method of claim 16, wherein real-world objects existing in the space are shown with the default overlay grid in the virtual reality display unit.

18. The method of claim 17, wherein, upon the searching of an existing object-library being positive and upon a real-world object being tracked at the position of a respective virtual object of the object-library and being identified as the respective virtual object, a stored relevance-marker of the respective virtual object is searched and the respective virtual object of the object-library is automatically assigned with the stored relevance-marker.

19. The method of claim 7, wherein a user is able to switch between marking involving:
the virtual objects of an object-library being shown by the virtual reality display unit for marking and not shown by the virtual reality display unit prior marking, and
the virtual objects of the object-library being marked independently to the display of the virtual reality display unit.

20. The method of claim 1, wherein the virtual objects of the object-library are shown by the virtual reality display unit in different shapes or not at all in dependence of relevance.

21. The method of claim 20, wherein at least one of
a virtual object is not shown if its relevance lies under a predefined value,
the virtual object is shown with a predefined texture if its relevance lies between a first range of values, and
the virtual object is shown as image of the real-world object if its relevance lies between a second range of values.
